(19) United States
(12) Patent Application Publication
(10) Pub. No.: US 2004/0090551 A1
(43) Pub. Date: May 13, 2004

(54) Auto focus system

(76) Inventor: Kunio Yata, Saitama-shi (JP)

Correspondence Address: HARNESS, DICKEY & PIERCE, P.L.C., P.O. BOX 8910, RESTON, VA, 20195, US

(21) Appl. No.: 10/695,824

(22) Filed: Oct. 30, 2003

(30) Foreign Application Priority Data
Nov. 1, 2002 (JP) 2002-319259

(51) Int. Cl. H04N 5/232; G03B 13/00

(52) U.S. Cl. 348/354

(57) ABSTRACT

In the autofocus system, a signal of the high-frequency component is extracted from a picture signal so that the major object in focus can be easily distinguished from other objects (background images). Then, the position of the major object moving on the viewing area is determined according to the signal of the high-frequency component. Thus, it is possible to modify the range of the focus area to include the determined position of the major object or modify the viewing area of the camera so that the focus area includes the position of the major object so as to keep focusing on the major object.

### BACKGROUND OF THE INVENTION

1. Field of the Invention

The present invention relates to an auto focus system, and in particular, to an auto focus system for automatically focusing on a desired object moving on a viewing area.

2. Description of the Related Art

An auto focus system used for a TV camera and so on adopts a contrast method in general. The contrast method adds up high-frequency components of picture signals in a certain range (focus area) out of the picture signals obtained from an image pickup device to obtain a focus evaluation value, and automatically adjusts a focus of a taking lens so that the focus evaluation value becomes the largest.

As for the TV camera in the past, a method of setting the focus area by fixing it at the center of the viewing area is general. However, if the focus area is fixed at the center of the viewing area, there is a drawback that the major object to be focused must be constantly placed at the center of the viewing area and so a condition for using the camera is limited.

Alternatively, Japanese Patent Application Publication No. 9-54244 discloses a TV camera wherein an operator can specify a position of the focus area with a track ball, a joystick or the like so as to change it to a desired position. In the case where an operator can specify and modify the position of the focus area with a track ball or the like, there is no restriction that the major object must be constantly placed at the center of the viewing area. In the case where the major object moves on a viewing area, however, there is a drawback that the position of the focus area must be changed accordingly and so camera operation becomes demanding.

### SUMMARY OF THE INVENTION

The present invention has been implemented in consideration of such circumstances, and its object is to provide an auto focus system capable of, in the case where the major object to be focused on moves, constantly focusing on the major object.

In order to attain the above-described object, the present invention is directed to an auto focus system, comprising: an auto focus device which acquires a focus evaluation value indicating a degree of sharpness of an object image in a predetermined focus area set up within a viewing area according to a picture signal obtained from a camera, controls a focus of a taking lens so that the focus evaluation value indicates a best focus, and automatically focuses on a major object in the focus area; a filter device which extracts a signal of a high-frequency component from the picture signal; a major object position determination device which determines a position on the viewing area of the major object focused by the auto focus device according to the signal of the high-frequency component extracted by the filter device; and a modification device which modifies at least one of a range of the focus area and the viewing area of the camera so that the focus area includes the position of the major object determined by the major object position determination device.

Preferably, the major object position determination device obtains by the filter device the signals of the high-frequency components corresponding to a first image picked up by the camera and a second image picked up by the camera after passage of a predetermined time from picking up of the first image, and compares the signal of the high-frequency component of the second image to the signal of the high-frequency component of the first image so as to acquire a shift amount of the position of the major object in the second image against the position of the major object in the first image.

Preferably, the modification device displaces the at least one of the range of the focus area and the viewing area of the camera by the shift amount acquired by the major object position determination device.

According to the present invention, the signal of the high-frequency component is extracted from the picture signal so that the major object in focus can be easily distinguished from other objects (background images). Then, the position of the major object moving on the viewing area is determined according to the signal of the high-frequency component. Thus, it is possible to modify the range of the focus area to include the determined position of the major object or modify the viewing area of the camera so that the focus area includes the position of the major object so as to keep focusing on the major object.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a block diagram showing configuration of a TV camera system to which an auto focus system according to an embodiment of the present invention is applied;

FIG. 2 is a diagram showing a setup example of a focus area;

FIG. 3 is an explanatory diagram used to describe a process of determining a position of a major object;

FIGS. 4(a) and 4(b) are explanatory diagrams used to describe the process of determining the position of the major object;

FIG. 5 is an explanatory diagram used to describe the process of determining the position of the major object; and

FIG. 6 is a flowchart showing a procedure for modifying the focus area.

### DETAILED DESCRIPTION OF THE PREFERRED EMBODIMENTS

Hereafter, preferred embodiments of an auto focus system according to the present invention will be described in detail by referring to the attached drawings.

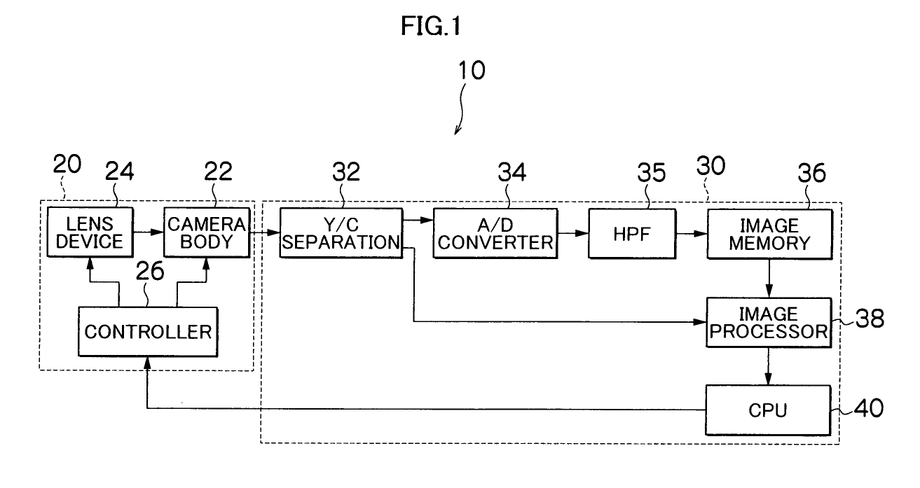

FIG. 1 is a block diagram showing configuration of a TV camera system to which an auto focus system according to an embodiment of the present invention is applied. As shown in FIG. 1, a TV camera system 10 according to this embodiment is comprised of a TV camera 20 and an image processing device 30.

The TV camera 20 is comprised of a camera body 22, a lens device 24, a controller 26 and so on, and is mounted on a pan head (not shown).

The camera body 22 has an image pickup device and a required processing circuit mounted thereon, and outputs as a picture signal an image (motion picture) formed on the image pickup device via an optical system (a taking lens) of the lens device 24 to the outside. Shooting operations on the camera body 22 such as a start and an end of shooting are controlled according to a control signal given from the controller 26.

The lens device 24 has optical elements such as motor-drivable focus lens and zoom lens, which move and thereby adjust a focus and a zoom of the TV camera 20. The operations on the lens device 24 such as the focus and zoom are controlled according to the control signal given from the controller 26 as with the camera body 22.

The image processing device 30 is comprised of various signal processing circuits such as a Y/C separation circuit 32, an A/D converter 34, a high-pass filter (HPF) 35, an image memory 36, an image processor 38 and a CPU 40, and effectively operates in the case where an auto focus mode is on.

In the case where the auto focus mode is on, the image processing device 30 has the picture signal outputted from the camera body 22 inputted thereto, and the picture signal is separated into a luminance signal (Y signal) and color difference signals (e.g., an R-Y signal and a B-Y signal) by the Y/C separation circuit 32. The luminance signal separated here is converted into a digital signal (hereafter, referred to as “image data”) by the A/D converter 34, and then has only a signal of a high-frequency component extracted therefrom by the high-pass filter 35. The signal of the high-frequency component extracted by the high-pass filter 35 is inputted to the image memory 36. It is possible, by having the signal of the high-frequency component extracted from the picture signal (luminance signal) by the high-pass filter 35, to easily distinguish the object in focus (major object) from the object out of focus by means of the signal.

The image processor 38 is given a synchronization signal of the picture signal from the Y/C separation circuit 32, and a data writing command is given from the image processor 38 to the image memory 36 according to the synchronization signal in required timing. Thus, the image memory 36 has image data (signal values of the high-frequency components of the luminance signals) of a plurality of frames at predetermined intervals stored therein.

The image processor 38 reads the image data in a predetermined focus area from the image data stored in the image memory 36, and outputs the read image data to the CPU 40. The CPU 40 calculates a focus evaluation value for evaluating a focal state in the above-described focus area according to the inputted image data. Then, the CPU 40 outputs the control signal to the controller 26 of the TV camera 20, and determines a focus position at which the focus evaluation value becomes the largest while moving the focus position of the lens device 24 so as to set the focus position at that position. To be more specific, the CPU 40 moves the focus position in a direction for increasing the focus evaluation value, and stops the focus position at a point where the focus evaluation value becomes the largest (this process is so-called mountain climbing AF). Thus, the focus is set in a focusing state.

The focus evaluation value is a value acquired by adding up the high-frequency components of the luminance signals in the focus area, and it shows a degree of sharpness (whether contrast is high or low) of an image in the focus area. According to this embodiment, the image data obtained by extracting the signals of the high-frequency components from the luminance signals is stored in the image memory 36 so that, as for a process of the CPU 40 for calculating the focus evaluation value, there is no need to extract the signals of the high-frequency components from the luminance signals.

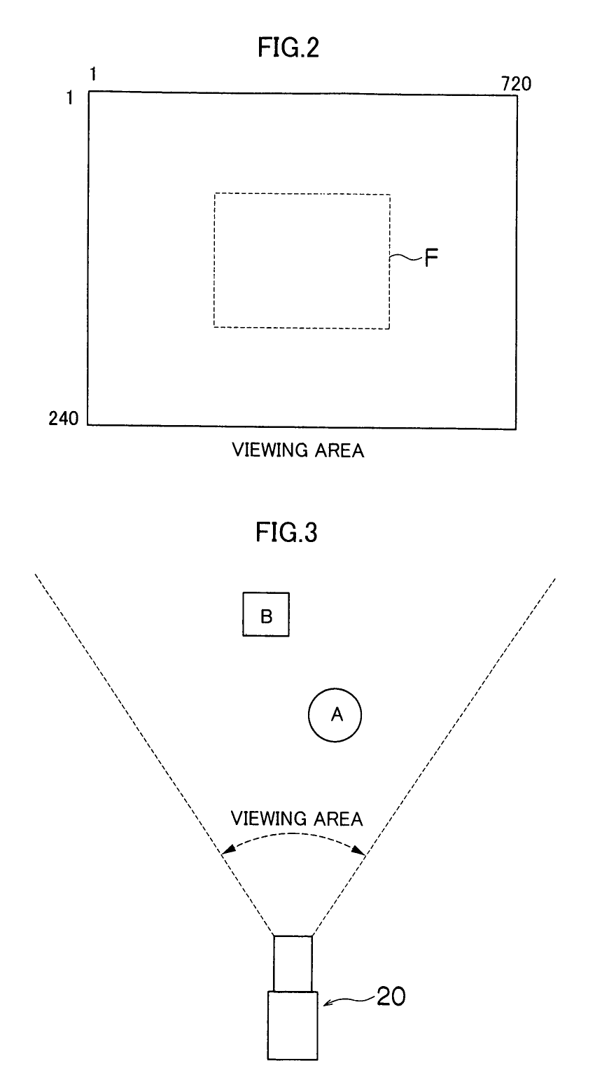

The image stored in the image memory 36 is stored as the image data having 720 pixels horizontally and 240 pixels vertically as shown in FIG. 2 for instance. A focus area F to be focused on is set as a rectangular area in the viewing area comprised of 720 pixels×240 pixels. The focus area F is fixed at the center of the viewing area in a fixed mode for instance, and moves for tracking a move of the major object in an automatic tracking mode. An operator can select the fixed mode and automatic tracking mode in the auto focus mode. As for the fixed mode, it is also feasible to have it fixed in a range arbitrarily specified by the operator.

In the case where it is set in the automatic tracking mode, the image processor 38 determines the position of the major object on a viewing area according to the image data of the latest shot image stored in the image memory 36 as mentioned later, and modifies the range (position) of the focus area F to include the determined position of the major object. Thus, the above-mentioned auto focus control (mountain climbing AF) is exerted to the image in the focus area F so as to keep focusing on the major object.

Hereafter, the process of the image processor 38 for modifying the range of the focus area F will be concretely described. First, to describe the process of determining the position of the major object in the latest shot image, the position of the major object in the latest shot image is determined as a shift amount against the position of the major object in the shot image as of the last time. It is assumed that the focus area F is set at a certain position on the viewing area now; for instance, it is set at the center of the viewing area in an initial state, and as shown in FIG. 3, a body A and a body B are placed in a viewing area of the TV camera 20, and the bodies A and B are shot as the objects in the focus area F. The body A is focused on by the auto focus control. To be more specific, the body A is the major object and the body B is a minor object.

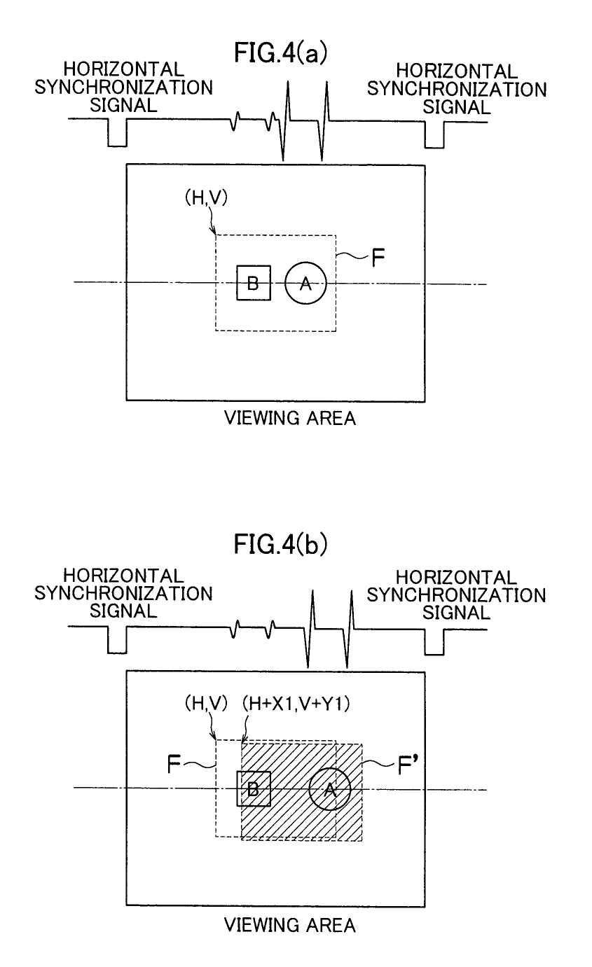

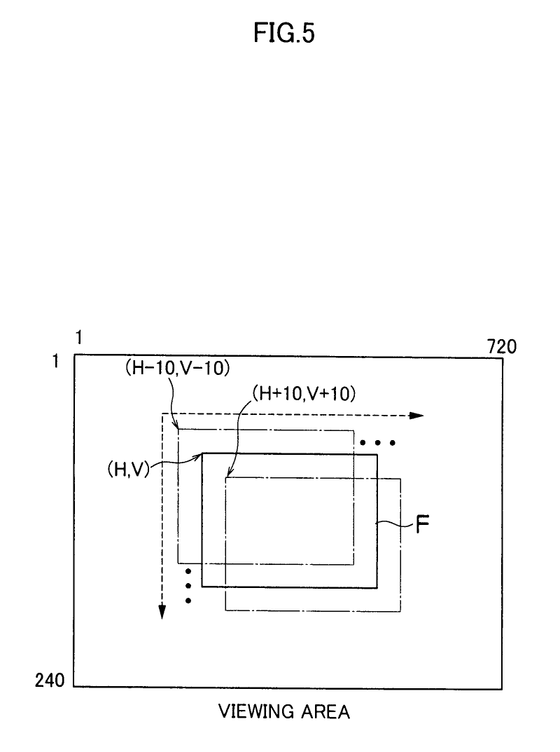

In this case, the images of the bodies A and B appear in the focus area F as shown in FIG. 4(a). With respect to the images of the bodies A and B, the image data stored in the image memory 36 is the high-frequency signal values (pixel values) of the luminance signals extracted by the high-pass filter 35, where the pixel value for the image of the body A in focus is much larger than the pixel value for the image of the body B out of focus. For instance, the pixel values of the pixels along a horizontal line at the center of the viewing area in FIG. 4(a) indicate the signals shown in the upper part of FIG. 4(a), and the pixel value for the image of the body B becomes negligibly small against the pixel value for the image of the body A. It is the same as to background images other than the body B. Therefore, it is also possible to consider that the image memory 36 has only the image data for the image of the body A, which is the major object, stored therein. The image data corresponding to the image in FIG. 4(a) is hereinafter referred to as an image (1).

Subsequently, it is assumed that the image data of the latest shot image is stored in the image memory 36 after passage of a predetermined time from storage of the image (1) in FIG. 4(a) (for instance, after passage of a one vertical synchronization period), and the image has changed as shown in FIG. 4(b) from the image (1). Here, the body A is moving. The image data stored in the image memory 36 corresponding to the image in FIG. 4(b) is hereinafter referred to as an image (2). In this case, the pixel values of the pixels along the horizontal line at the center of the viewing area in FIG. 4(b) indicate the signals shown in the upper part of FIG. 4(b).

When the image data of the images (1) and (2) is thus stored in the image memory 36, the image processor 38 acquires the position of the body A as the major object in the image (2) as the shift amount of the body A against the position thereof in the image (1).

Regarding the currently set focus area F as a signal extraction range of the image (1), the image processor 38 extracts the image data (pixel value) of the image (1) in that range from the image memory 36. As shown in FIG. 5, the coordinates in the upper left corner of the currently set focus area F are represented as (H, V) (H indicates the number of pixels from the left end on the viewing area, and V indicates the number of pixels from the upper end thereon).

Regarding the rectangular range of the same size as the focus area F and having the coordinates (H+X, V+Y) (X and Y are predetermined integers) in the upper left corner as the signal extraction range of the image (2), the image processor 38 extracts the image data of the image (2) in that range from the image memory 36. Then, the image processor 38 acquires a difference in the pixel values between the corresponding pixels in the respective signal extraction ranges of the images (1) and (2), and acquires a value (as an integrated value) having added up absolute values of the differences as to all the pixels in the signal extraction ranges. The pixels corresponding to the respective signal extraction ranges of the images (1) and (2) are the pixels at the same positions in the respective signal extraction ranges of the images (1) and (2), where a pixel (x, y) of the image (1) and a pixel (x+X, y+Y) of the image (2) suit.

The image processor 38 acquires such integrated values while shifting the signal extraction range of the image (2) (changing the values of X and Y). For instance, as shown in FIG. 5, it acquires 21×21 integrated values in total while shifting each of X and Y one by one from −10 to +10. Then, the image processor 38 determines the smallest of the integrated values thereby acquired, and determines the shift amount of the signal extraction range of the image (1) against the signal extraction range of the images (2) when the smallest integrated value is acquired. For instance, if the signal extraction range of the image (2) on acquiring the smallest integrated value is (H+X1, V+Y1) as the coordinates in the upper left comer, the shift amount of the signal extraction range is (X1, Y1) which is the amount shifted by X1 horizontally and Y1 vertically.

Here, the case where the integrated value becomes the smallest is the case where the positions of the body A in the respective signal extraction ranges of the images (1) and (2) coincide, and the shift amount of the signal extraction range determined as mentioned above indicates the shift amount of the body A on the viewing area. Therefore, the position of the body A as the major object in the image (2) is determined by thus determining the shift amount of the signal extraction range.

Subsequently, the image processor 38 sets the range of a new focus area F′ to the position shifted by the shift amount (X1, Y1) against the currently set focus area F. To be more specific, as shown in FIG. 4(b), when the coordinates in the upper left corner of the currently set focus area F are (H, V), the image processor 38 sets the range of the new focus area F′ (shaded range) to the position of the coordinate (H+X1, V+Y1) in the upper left corner. Thus, the range of the focus area is modified to include the position of the body A as the major object.

After the range of the focus area is modified as described above, the object in the range of the new focus area is rendered as a subject of focusing so as to exert the above-mentioned auto focus control.

The process of modifying the range of the focus area may be performed every time when reading the image data in the focus area from the image memory 36 for the sake of acquiring the focus evaluation value in order to modify the focus area, or may be performed in another timing.

The signal extraction ranges of the images (1) and (2) are the ranges of the same size as the focus area in the above description; however, they do not necessarily have to be of the same size.

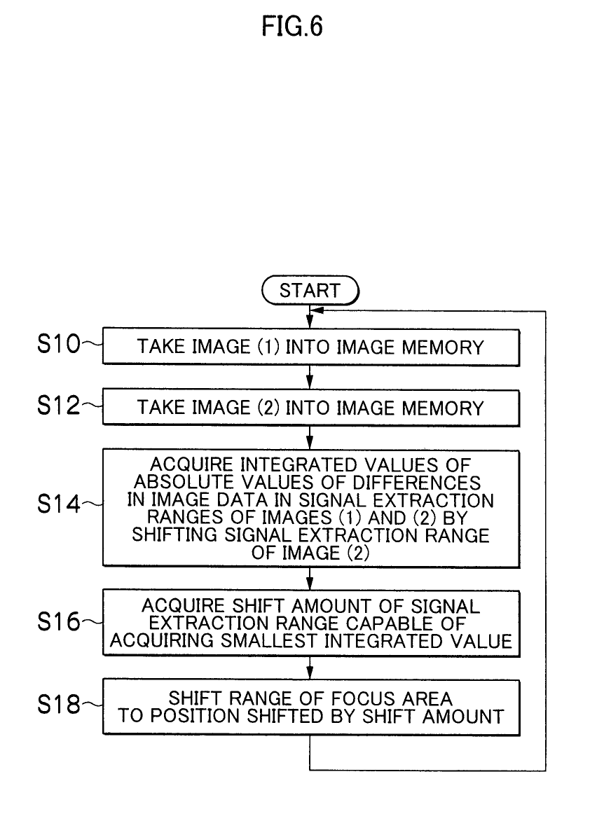

Next, the procedure of modifying the focus area will be described by using a flowchart in FIG. 6.

First, the image processor 38 takes into the image memory 36 the image data of one viewing area (image (1)) having passed the high-pass filter 35 and having the signal of the high-frequency component extracted (step S10). Subsequently, the image processor 38 takes the image data of one viewing area (image (2)) into the image memory 36 likewise after passage of a predetermined time (step S12). Then, as described above, the image processor 38 reads pixel value data (pixel value) of the signal extraction range (focus area) of the image (1) and the pixel value of the signal extraction range of the image (2) from the image memory 36, and acquires the integrated values by adding up absolute values of the differences in the pixel values of corresponding pixels. The image processor 38 also acquires the integrated values likewise by shifting the signal extraction range of the image (2) on the viewing area by a predetermined shift amount (step S14).

Next, of the integrated values acquired in the step S14, the image processor 38 acquires the shift amount of the signal extraction range when the smallest integrated value is acquired (step S16), and sets the range having shifted the currently set focus area by the shift amount as the new focus area (step S18). The image processor 38 repeats the above steps S10 to S18.

According to the above embodiment, the range of the focus area is modified according to the position of the major object (shift amount) so that the major object moving on the viewing area is within the range of the focus area. However, it is also possible, in the case of a system capable of modifying the viewing area by panning or tilting the TV camera as with a remote-control camera platform, to modify the viewing area of the camera so that the major object is within the focus area according to its position (shift amount). For instance, the shift amount in the viewing area of the camera (shift amount in the units of the number of pixels on the viewing area) may be the shift amount acquired as in the case of modifying the range of the focus area.

According to the above embodiment, the range of the focus area and the viewing area of the camera are shifted without changing in the size. It is also feasible, however, to exert control to modify the size of the range of the focus area and the viewing area of the camera according to the position of the major object so that the major object is within the focus area.

According to the above-mentioned series of embodiments, the cases of applying the present invention to the TV camera system were described as examples. However, it is not limited thereto but may also be applied to a video camera and a still camera for shooting a static image.

As described above, according to the present invention, the signal of the high-frequency component is extracted from the picture signal so that the major object in focus can be easily distinguished from other objects (background images), and the position of the major object moving on the viewing area is determined according to the signal of the high-frequency component. Thus, it is possible to modify the range of the focus area to include the determined position of the major object or modify the viewing area of the camera so that the focus area includes the position of the major object so as to keep focusing on the major object.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An auto focus system, comprising:
an auto focus device which acquires a focus evaluation value indicating a degree of sharpness of an object image in a predetermined focus area set up within a viewing area according to a picture signal obtained from a camera, controls a focus of a taking lens so that the focus evaluation value indicates a best focus, and automatically focuses on a major object in the focus area;
a filter device which extracts a signal of a high-frequency component from the picture signal;
a major object position determination device which determines a position on the viewing area of the major object focused by the auto focus device according to the signal of the high-frequency component extracted by the filter device; and
a modification device which modifies at least one of a range of the focus area and the viewing area of the camera so that the focus area includes the position of the major object determined by the major object position determination device.

2. The auto focus system as defined in claim 1, wherein the major object position determination device obtains by the filter device the signals of the high-frequency components corresponding to a first image picked up by the camera and a second image picked up by the camera after passage of a predetermined time from picking up of the first image, and compares the signal of the high-frequency component of the second image to the signal of the high-frequency component of the first image so as to acquire a shift amount of the position of the major object in the second image against the position of the major object in the first image.

3. The auto focus system as defined in claim 2, wherein the modification device displaces the at least one of the range of the focus area and the viewing area of the camera by the shift amount acquired by the major object position determination device.
